(19) United States
(12) Patent Application Publication
(10) Pub. No.: US 2006/0033631 A1
(43) Pub. Date: Feb. 16, 2006

(54) Pressure based battery powered wireless cellular liquid level tank monitor and level reporting system

(75) Inventors: Kenneth Alan Cupples, Knoxville, TN (US); James Robert Champion, Maryville, TN (US); Wojtek Miller, Knoxville, TN (US)

Correspondence Address: REINHART BOERNER VAN DEUREN LTD., 483 NORTH MULFORD ROAD, SUITE 7, ROCKFORD, IL, 61107, US

(73) Assignee: Ranco Incorporated of Delaware, Wilmington, DE (US)

(21) Appl. No.: 11/199,749

(22) Filed: Aug. 9, 2005

Related U.S. Application Data
(60) Provisional application No. 60/600,348, filed on Aug. 10, 2004.

(51) Int. Cl. G08B 21/00

(52) U.S. Cl. 340/612; 340/618

(57) ABSTRACT

A method, apparatus, and system for remotely monitoring a liquid level in a tank are provided by broadcasting a signal indicative of the liquid level in the tank directly to a cellular communication network from a stand-alone liquid level monitor operatively attached to the tank. The stand-alone monitor is battery powered and includes a processor configured for conserving power by operating the monitor according to a periodic sampling and broadcast schedule, which may be modified by signals received at the monitor directly from the cellular communications network.

### CROSS-REFERENCE TO RELATED PATENT APPLICATIONS

This patent application claims the benefit of U.S. Provisional Patent Application No. 60/600,348, filed Aug. 10, 2004, the teachings and disclosure of which are hereby incorporated in their entireties by reference.

### FIELD OF THE INVENTION

This invention relates to monitoring the level of a fluid in storage tanks, and more particularly to a tank monitoring apparatus and method for monitoring the fluid level in a tank from a remote location, via a cellular communication network.

### BACKGROUND OF THE INVENTION

Fluids such as gasoline, propane, fertilizer, chemicals, fuel oil, and the like are often stored in tanks located in remote areas. It is desirable, and known to equip such remote storage tanks with monitoring equipment having the capability of detecting fluid level, or changes in fluid level, in the tank, and reporting this information to a person, or data collection center located some distance from the tank.

In one prior approach, to monitoring a tank, in this fashion, a monitoring device attached to the tank wirelessly transmits a signal indicative of the fluid level in the tank to a controller located relatively close to the tank. The controller then transmits data derived from the monitor signal to a data collection center located some distance from the tank, through dedicated, or commercially available, telephone communication networks. Examples of this approach are provided by equipment and systems marketed under the trade mark CENTERON®, by the assignee of the present invention.

Although the prior systems work well in a large number of applications, there are some applications in which it is desirable to eliminate the need for having a controller located in proximity to the tank in which the liquid level is being monitored. Specifically, in applications where one or more tanks are permanently located in a grouping of tanks adjacent a processing or distribution facility, for example, the prior approach of having a dedicated controller located near the tanks provides many advantages. For portable tanks, however, or where only a single tank is utilized in a remote location, it is desirable to provide an improved apparatus, system, and method for monitoring the level of fluid in the tank with simplified equipment that eliminates the need for having a controller in relatively close proximity to the tank being monitored.

It is desirable, therefore, to provide an improved method, apparatus, and system for monitoring the level of a liquid in a tank in applications which are less than ideally served by the prior approaches to performing such remote monitoring operations.

### BRIEF SUMMARY OF THE INVENTION

The invention provides an improved method, apparatus, and system for remotely monitoring a liquid level in a tank, by broadcasting a signal, indicative of the liquid level in the tank, directly to a cellular communication network, from a liquid level monitor operatively attached to the tank. In some forms of the invention, the liquid level monitor attached to the tank is controlled by signals received directly from the cellular communication network.

In one form of the invention, a stand-alone tank monitor apparatus is provided, for monitoring a liquid-level in a tank. The stand-alone tank monitor apparatus includes a liquid-level sensor providing a sensor-signal indicative of the liquid-level in the tank, and a cellular communication device operatively connected to the liquid-level sensor. The cellular communication device is configured for transmitting a broadcast output signal directly to a cellular communication network. The monitor apparatus may include a remotely operable power supply, and the power supply may include a battery. The monitor apparatus may further include a processor for conserving power by operating the monitor periodically rather than continuously. The processor, of the monitor apparatus may periodically sample and store values of these sensor-signal, according to a sampling schedule, and cause the cellular communication device to transmit the broadcast output signal according to a periodic broadcast schedule differing from the sampling schedule.

In a tank monitor apparatus, according to the invention, the sensor-signal may be an analog signal. Where the sensor-signal is an analog signal, the tank monitor apparatus may include a signal processing circuit having a processor, an analog signal conditioner, an analog to digital (A/D) converter, a power supply, and an Amps Cellular Serial modem and antenna. The signal processing circuit may be configured such that the analog signal conditioner receives the analog sensor-signal, and provides a conditioned analog signal to the A/D converter, with the A/D converter converting the conditioned analog signal to a digital signal, and the processor converting the digital signal to the broadcast output signal for transmission by the cellular modem and antenna.

The invention may also take the form of a tank level monitoring system, utilizing a stand-alone tank monitor apparatus, according to the invention.

The invention may further take the form of a method for remotely monitoring a liquid-level in a tank, wherein the method includes broadcasting a signal indicative of the liquid level in the tank directly to a cellular communication network from a liquid level monitor operatively attached to the tank.

In some forms of the invention, a cellular communication device in a monitor apparatus, according to the invention, is configured for also receiving a broadcast input signal directly from the cellular communication network for modifying a sampling and/or broadcast schedule of the cellular communication device in the monitor apparatus.

The invention may further include providing a data collection server, operatively connected to the cellular communications network, for receiving the broadcast output signal from the cellular communications network.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an illustration of an exemplary embodiment of a tank monitoring system, according to the invention, in which a stand-alone monitor attached to a storage tank provides information relating to the level of fluid in the tank by broadcasting a signal indicative of the level in the tank directly to a cellular communication network, which then relays the liquid level information from the monitor to a remote data collection center.

FIG. 2 shows an exemplary embodiment of a stand-alone tank monitor apparatus, according to the invention.

FIG. 3 is a schematic illustration of internal components of the stand-alone tank monitor apparatus of FIG. 3, according to the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

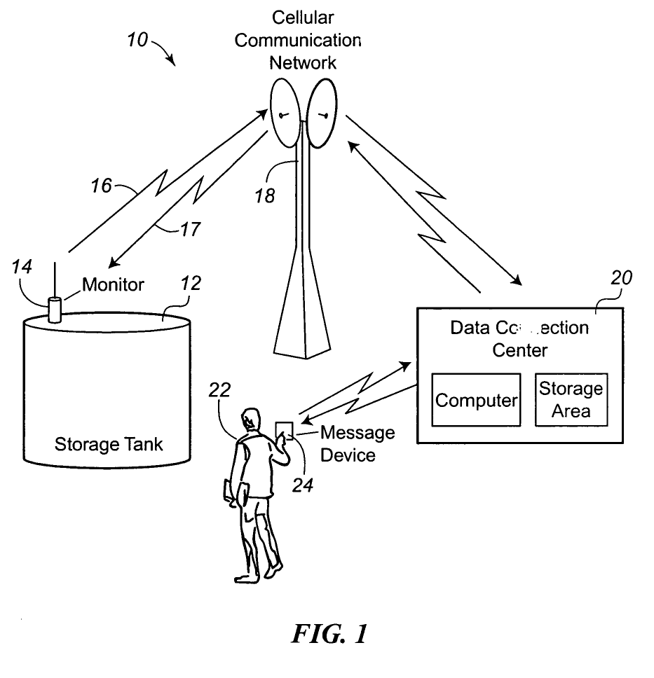

FIG. 1 illustrates an exemplary embodiment of a tank fluid level monitoring system 10, for monitoring a liquid level of the fluid in a tank 12, using a stand-alone tank monitor apparatus 14 for sending a broadcast output signal 16, indicative of the liquid level in the tank, directly to a cellular communication network, illustrated by the cell tower 18 in FIG. 1. The cellular communication network 18 then communicates, either wirelessly as shown in FIG. 1, or over a standard land-line telephone connection, to a data collection center 20 of the exemplary embodiment of the tank monitoring system 10. Information from the data collection center is provided to a user 22 via a message device 24, which may be a standard cellular phone, PDA, or a dedicated wireless or non-wireless output device.

In the exemplary embodiment of the tank level monitoring system 10, broadcast input signals 17 may be sent back to the stand-alone tank monitor 14, directly from the cellular communications network 18, to modify certain sampling and reporting instructions within the monitor 14, in a manner described in more detail below. Such input instructions may be provided by the user from the data collection center 20, or be provided as inputs through the message device 24.

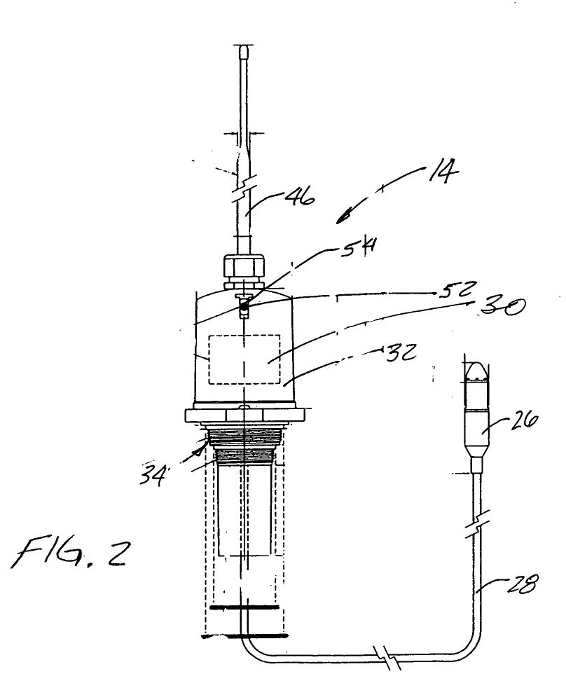

FIG. 2 shows an exemplary embodiment of the stand-alone tank monitor apparatus 14, of the exemplary embodiment of the tank monitoring system 10. The tank monitor apparatus 14 includes a submersible pressure sensor 26 connected by an umbilical cable 28 to internal components 30 of the tank monitor 14, located inside of a fluid-tight housing 32 of the tank monitor 14. A portion of the housing 32 of the tank monitor 14 is threaded, as indicated at 34 in FIG. 2, so that the tank monitor 14 can be sealingly installed into a standard bung-hole (not shown) of the storage tank 12, with the umbilical cord 28 and pressure sensor 26 extending through the bung-hole into the tank 12, and the umbilical cord 28 having a suitable length, for example 12-20 feet, to allow the pressure sensor 26 to rest on or very near the bottom of the storage tank 12.

Examples of tank monitoring apparatuses, of various type suitable for use in the exemplary embodiment, are illustrated in commonly assigned patent applications bearing the Attorney Docket Nos. 502922 and 502924, the teachings and disclosures of which are incorporated herein in their entireties by reference. Specifically, the patent application bearing Attorney Docket No. 502922 discloses a tank monitoring apparatus having an externally protruding antenna, and the patent application bearing Attorney Docket No. 502924 discloses a tank monitor apparatus having an integral internal vent for the pressure sensor. Those having skill in the art will recognize, however, that a stand-along tank monitor, according to the invention, may take a variety of forms other than those specifically disclosed herein or in the referenced commonly assigned patent applications.

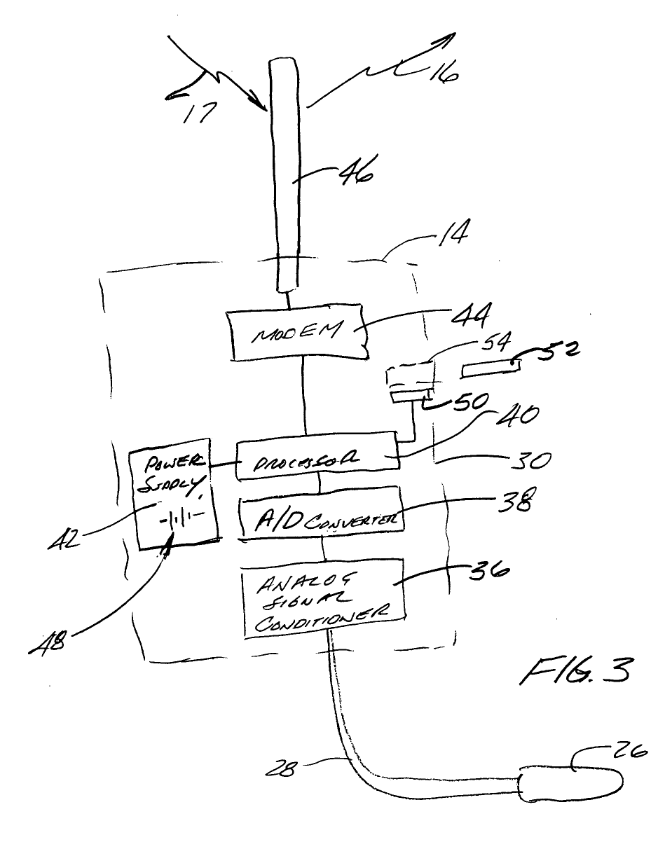

As shown in FIG. 3, the signal processing circuitry 30, of the exemplary embodiment of the stand-alone tank monitor 14, includes an analog signal conditioner 36, an analog to digital (A/D) converter 38, a processor 40, a power supply 42 and Amps Cellular Serial Modem 44, and an antenna 46. The modem 44 and antenna 46 comprising a cellular communication device 47, according to the invention, operatively connected to the pressure sensor, in part, by the remaining components 37, 38, 40, 42 of the signal processing circuitry 30. In the exemplary embodiment of the tank monitor apparatus 14, the antenna 46 protrudes beyond the housing 32 of the monitor 14, but it is understood, that in other embodiments of the invention, antennas which do not protrude beyond the housing 32 may also be utilized in practicing the invention.

In the exemplary embodiment of the tank monitor 14, the pressure sensor 26 includes a passive, piezo-resistive pressure sensor (not shown), which provides an analog output sensor-signal indicative of fluid pressure at the bottom of the tank 12 as will be understood by those having skill in the art, the liquid level in the tank 12 can be readily computed from such a pressure signal.

The analog signals generated by the pressure sensor 26 are communicated to the analog signal conditioner 36, via wires enclosed in the umbilical cable 28. The analog sensor-signal from the pressure sensor 26, is conditioned by the analog signal conditioner 36, and provided to the A/D converter 38. The A/D converter 38 converts the conditioned analog signal to a digital signal, which is provided to the processor 40. The processor 40 converts the digital to the broadcast output signal, for transmission by the cellular modem 44 and antenna 46.

The power supply 42, of the exemplary embodiment, includes a battery 48, so that the tank monitor apparatus 14 can provide stand-alone operation, without connection to any type of power source external from the tank monitor 14. It is understood, however, that in other embodiments of the invention, it may be desirable to have the power supply include other remotely operable power-producing components, such as a solar cell, or fuel cell, etc.

In order to facilitate stand-alone operation of the tank monitor apparatus 14, it is desirable to include certain power-conserving provisions within the tank monitor apparatus 14. To this end, the tank monitor apparatus 14, of the exemplary embodiment, includes a magnetically-actuated switching element 50, which is configured to turn off the monitor when a magnet 52 is inserted into a pocket 54 in the housing 32 of the monitor 14. A magnetically actuated switch is preferable, in the exemplary embodiment of the invention, as compared to a mechanically-actuated switch extending through the housing 32, in order to facilitate maintaining a fluid-type construction of the housing 32. For portable tanks, it may be desirable, for instance, to keep the monitor 14 in a turned-off state until it is installed on the tank 12, and fluid is placed in the tank 12. It may also be desirable to keep the monitor turned off, with the magnet 52, when the tank 12 is being transported.

In order to further facilitate stand-alone operation of the tank monitor 14, the processor 40, of the exemplary embodiment is configured to conserve power by operating the monitor 14 only periodically, rather than continuously. Specifically, the processor 40 of the exemplary embodiment of the tank monitor 14 conserves power by operating the monitor 14 only periodically, rather than continuously. For example, the processor may be configured to periodically sample and store values of the sensor-signal, according to a sampling schedule, and to periodically cause the cellular communication device 47 to transmit the broadcast output signal 16, according to a broadcast schedule which differs from the sampling schedule. The processor 40 may be further configured, to interrupt the broadcast schedule, and provide special broadcasts based on the stored values of sensor signals, or changes in sensor signals, as a security measure, to indicate sudden and significant increases or decreases in the level of liquid in the tank 12.

In some embodiments of the invention, the processor 40 may be further configured to allow variation of schedules for sampling and broadcast, and security set points, when the broadcast input signal 17 is received, from the cellular communications network 18, by the cellular communication device 47 of the stand-alone tank monitor apparatus 14.

Various desirable configurations for a processor, in a stand-alone tank monitor apparatus 14, according to the invention, and methods for operating a stand-alone monitor according to the invention, are disclosed and taught in commonly assigned U.S. patent application bearing Attorney Docket No. 502917, the teachings and disclosure of which are incorporated herein, in their entirety, by reference.

All references, including publications, patent applications, and patents cited herein are hereby incorporated by reference to the same extent as if each reference were individually and specifically indicated to be incorporated by reference and were set forth in its entirely herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A stand-alone tank monitor apparatus, for monitoring a liquid level in a tank, the tank monitor apparatus comprising:
a liquid-level sensor providing a sensor-signal indicative of the liquid level in the tank; and
a cellular communication device operatively connected to the liquid level sensor and configured for transmitting a broadcast output signal, indicative of the liquid level in the tank, directly to a cellular communications network.

2. The monitor apparatus of claim 1, wherein the liquid level sensor is a pressure responsive sensor.

3. The monitor apparatus of claim 1, wherein the monitor includes a remotely operable power supply.

4. The monitor of claim 3, wherein the power supply comprises a battery.

5. The monitor apparatus of claim 2, further comprising a processor for conserving power by operating the monitor periodically, rather than continuously.

6. The monitor apparatus of claim 5, wherein the processor periodically samples and stores values of the sensor-signal according to a sampling schedule, and periodically causes the cellular communication device to transmit the broadcast signal according to a broadcast schedule differing from the sampling schedule.

7. The system of claim 6, wherein the cellular communication device is also configured for receiving a broadcast input signal for modifying the sampling and/or broadcast schedule.

8. The tank monitor apparatus of claim 1, wherein the sensor-signal is an analog signal, and the apparatus further comprises:
a signal processing circuit including a processor, an analog signal conditioner, an analog to digital (A/D) converter, a power supply, and an Amps Cellular Serial modem and antenna;
the signal processing circuit being configured such that the analog signal conditioner receives the analog sensor-signal, and provides a conditioned analog signal to the A/D converter, the A/D converter converts the conditioned analog signal to a digital signal, and the processor converts the digital signal to the broadcast signal for transmission by the cellular modem and antenna.

9. The tank monitoring apparatus of claim 8, wherein the power supply is at least partially battery powered.

10. A tank level monitoring system, for monitoring a liquid level in a tank, the tank level monitoring system comprising:
a stand-alone tank monitor apparatus including a liquid-level sensor, and a cellular communications device;
the liquid-level sensor providing a sensor-signal indicative of the liquid level in the tank; and
the cellular communication device operatively connected to the liquid level sensor and configured for transmitting a broadcast output signal, indicative of the liquid level, directly to a cellular communications network.

11. The monitor apparatus of claim 10, wherein the liquid level sensor is a pressure responsive sensor.

12. The system of claim 10, wherein the monitor apparatus includes a remotely operable power supply.

13. The system of claim 12, wherein the power supply comprises a battery.

14. The system of claim 13, further including a processor for conserving power by operating the monitor periodically, rather than continuously.

15. The system of claim 14, wherein the processor periodically samples and stores values of the sensor-signal according to a sampling schedule, and periodically causes the cellular communication device to transmit the broadcast signal according to a broadcast schedule differing from the sampling schedule.

16. The system of claim 15, wherein the cellular communication device is also configured for receiving a broadcast input signal for modifying the sampling and/or broadcast schedule.

17. The system of claim 10, further comprising a data collection server, operatively connected to the cellular communications network for receiving the broadcast output signal.

18. The system of claim 17, wherein the cellular communication device in the monitor apparatus is also configured for receiving a broadcast signal directly from the cellular communication network, and the data collection server is configured and operatively connected to the cellular communication network for sending a broadcast input signal to the cellular communication device of the monitor apparatus via the cellular communication network.

19. A method for remotely monitoring a liquid level in a tank comprising broadcasting a signal indicative of the liquid level in the tank directly to a cellular communication network from a liquid level monitor operatively attached to the tank

20. The method of claim 19, further comprising determining the liquid level in the tank with a pressure based sensor.

21. The method of claim 19, further comprising:
periodically sampling and storing liquid levels according to a sampling schedule; and
broadcasting the broadcast signal only periodically, according to a broadcast schedule differing from the sampling schedule.

22. The method of claim 21, further comprising modifying the sampling and/or broadcast schedule in accordance with a broadcast input signal received by the liquid level monitor directly from the cellular communication network.
